(19) United States
(12) Patent Application Publication
(10) Pub. No.: US 2004/0248029 A1
(43) Pub. Date: Dec. 9, 2004

(54) Lithographic printing plate system and method for manufacturing the plate system

(75) Inventors: Angelo Paulesu, Milano (IT); Ubaldo Contini, Legnano (IT); Amilcare Cattaneo, Busto Arsizio (IT)

Correspondence Address: MODIANO & ASSOCIATI, Via Meravigli, 16, Milano, 20123, IT

(73) Assignee: DIGITAL MIND S.R.L.

(21) Appl. No.: 10/816,870

(22) Filed: Apr. 5, 2004

(30) Foreign Application Priority Data
Jun. 4, 2003 (IT) MI2003A001125

(51) Int. Cl. G03C 8/00

(52) U.S. Cl. 430/204

(57) ABSTRACT

A lithographic printing plate system comprising a plate that is suitable for inkjet printing and a method for preparing the plate system comprising a support and a first composition that comprises at least one anionic compound and is spread onto the support; the lithographic support can be made for example of paper, electrograined-anodized aluminum, or flexible plastic polymer rendered hydrophilic beforehand by means of a specific surface treatment; an image that is faithful to the original is then reproduced on the lithographic plate with the aid of an inkjet printing system and of a second composition that contains at least one cationic compound, such as a diazo compound.

The present invention relates to a plate system for lithographic printing and to a method for preparing it, wherein such plate system comprises a lithographic plate that is particularly but not exclusively suitable for use in combination with an inkjet printing system.

### BACKGROUND OF THE INVENTION

Offset printing and webfed offset printing are the technological evolution of the known lithographic printing process, which uses the principle of repellency between an aqueous phase that contains various types of highly diluted substances and an ink that comprises greasy and sticky substances, such as for example resins, oils and pigments of different kinds.

Offset printing and webfed offset printing technique has recently advanced considerably thanks to the optimization of methods such as surface satin finishing of aluminum and electrochemical grinding and anodizing of metallic supports, which are suitable to increase the surface area of the treated material and accordingly increase its capacity to retain a sufficient reserve of water, which is needed to ensure the balance between the water and the greasy ink during the printing process.

Supports prepared in this manner are currently coated with photosensitive materials (particularly diazo resins) which, if subjected to a photoengraving and developing process of the photographic type, allow to provide images that conform to the original for a large number of copies.

The electrograining method consists of a process for electric corrosion or electric satin finishing of the metallic surface by means of highly diluted acids (such as for example hydrochloric acid, nitric acid, phosphoric acid) in a low-voltage moderate-intensity alternating current.

This increases by 50-100 times the upper internal and external surface of the treated material per unit of available area, so as to produce a reserve of water that is necessary to ensure the balance between water and greasy ink during the subsequent printing step.

At this point, the resulting plate can be presensitized by coating or covering with photosensitive substances (generally sensitive to light comprised between 340 nm and 480 nm) and sold as it is.

Even more recently, as a consequence of the introduction of new technologies, there has been a transition toward the use of heat-sensitive resins instead of photosensitive ones. In this second case, the image to be reproduced is recorded beforehand by means of a RIP process (image reproduction process) on a suitable medium such as a compact disc (hereinafter CD) or digital video disc (hereinafter DVD) and then sent by means of a computer to a flat or rotary laser unit. This apparatus is conventionally designated by the expression “computer to plate” (hereinafter CTP) and uses thermal laser diodes and a heat-sensitive plate on which the original image is to be reproduced.

Thermal diodes modify (for example chemically or physically) the potential selective development agents and by affecting only certain regions of the plate differentiate the positive areas from the negative areas (or vice versa, depending on the type of composition used).

This technology can be applied by coupling the resins cited above to all the types of supports conventionally used and preferably to metallic supports. Supports made of electrograined and anodized aluminum, capable of receiving and bonding nonspecifically positive or negative heat-sensitive materials that can be processed with laser diodes that have a high resolution in terms of dpi (dots per square inch) and with heat sensitivities that coincide and are comprised between 830 nm and 1065 nm, in fact lend themselves well to this purpose.

However, plates exposed in this manner must still be subjected to a suitable developing process of the photographic type, during which the composition modified (or vice versa not modified) by the diodes, which covers the so-called non-image areas, is removed.

Furthermore, up to now a technology such as the one described above has not yield great advantages in financial terms or in terms of time required for printing with respect to more conventional technologies.

Finally, up to now the considerable cost of anodized aluminum plates and of sophisticated CTP systems has limited their application to users requiring high productivity per hour and capable of sending a large number of plates to the printing room.

For this and other reasons, considerable research has been conducted with the aim of identifying an alternative method that would allow to obtain lithographic plates based on a different concept.

In this regard, U.S. Pat. No. 5,852,975 teaches to manufacture a lithographic printing plate suitable for use with inkjet printers, which is driven by an electrostatic charge (a system known as LBP), which consists of a support of different materials (such as for example anodized aluminum or flexible plastic material) coated with a material that is defined as suitable to receive the image. The fundamental characteristics of this material are on the one hand its ability to bind the ink that will be applied and on the other hand its ability to considerably increase its own hydrophilicity as a consequence of a treatment performed only on the regions that are not covered by the ink with an acid aqueous etching solution. In particular, this last treatment is essential in order to be able to desensitize the plate, thus separating the so-called “image” areas from the so-called “non-image” areas. Therefore, in certain aspects this treatment can be likened to a conventional photographic development process, and is moreover absolutely necessary in order to be able to perform the actual lithographic printing step.

Among the materials that are capable of radically modifying their own hydrophilicity as a consequence of treatment with diluted acid solutions, mention is made of clay, zinc oxide, titanium oxides and aluminum silicates.

Moreover, U.S. Pat. No. 5,852,975 also stresses that it is essential to impart a slight unevenness to the surface that will receive the image by using particular pigments that have a well-defined particle size. Control of this unevenness is described as essential in order to improve parameters that are fundamental for the good outcome of the printing process, such as for example the ability of the surface of the support to retain water, the adhesiveness of the ink and the duration over time of a satisfactory printed image quality.

The ink used by U.S. Pat. No. 5,852,975 must be melted before it is sprayed, and upon contact with the support, which is colder, it hardens again and is thus fixed to the plate, consequently forming the image.

However, it would be desirable to have completely different technological solutions that allow to perform a printing process at accessible costs by bypassing the need to have expensive CTP systems.

Likewise, it would be desirable to be able to easily provide a large number of copies with good fidelity to the original without having to necessarily resort to a step for the photographic developing of the plate system or to long and laborious support preparation procedures.

Moreover, the need is also felt to be able to have a plate system that can be prepared rapidly and uses easily available printing means and a wide range of inks.

### SUMMARY OF THE INVENTION

Therefore, in view of the above, the aim of the present invention is to provide a method for preparing a lithographic printing plate system that overcomes the drawbacks of the prior art.

Within this aim, an object of the present invention is to provide a plate system for inkjet lithographic printing that is different and qualitatively superior with respect to known products.

Another object is to provide a first composition and a support that allow to improve the production of lithographic plates that can be used in particular in combination with inkjet printing systems.

Another object is to provide a second composition that allows to improve the lithographic printing process.

Another object sought herein is to provide a particularly advantageous use of a plate and of a second composition, both prepared according to the invention.

This aim and these and other objects that will become better apparent hereinafter are achieved by a method for producing a lithographic printing plate system, comprising the steps of: providing a plate that is capable of receiving an image to be reproduced and comprises a first composition that comprises at least one anionic compound b) transferring an image to be reproduced onto said plate with the aid of a second composition and of an inkjet device, wherein said second composition comprises at least one cationic compound.

### DESCRIPTION OF THE PREFERRED EMBODIMENTS

In a preferred embodiment, the method according to the invention comprises the steps of: a) providing a plate that is capable of receiving an image to be reproduced, said plate comprising i) said first composition, which comprises at least one water-soluble polymer; at least one inorganic pigment and at least one initiator, wherein said initiator comprises at least one anionic compound; ii) a support that is capable of binding to the first composition i); b) transferring an image to be reproduced onto said plate with the aid of a second composition and of an inkjet device, wherein said second composition comprises at least one cationic compound.

In a preferred manner, said water-soluble polymer comprises polyvinyl alcohol.

Advantageously, the anionic compound of said first composition is effectively included in the initiator. However, ingredients of the first composition (such as for example said water-soluble polymer) may also comprise at least one anionic compound.

According to a particularly advantageous embodiment, the water-soluble polymer is used in mixture with at least one water-dispersible polymer, and the first composition further comprises at least one ingredient selected from the group that comprises at least one crosslinking agent, at least one catalyst for the crosslinking process, at least one surfactant and at least one product that improves the degree of reproduction of images and characters.

In another equally advantageous embodiment, the method according to the invention comprises, after step b), an additional step of rendering said image recorded on the plate system permanent by means of a fixing treatment, said fixing depending on the type of said second composition that is used.

The expressions “anionic compound” and “cationic compound” are used to designate a compound that has respectively at least one anionic portion and at least one cationic portion. The compound can in any case also be provided as a salt.

A first aspect of the invention relates to a method for preparing a plate system for lithographic printing. In preferred embodiments, the plate system comprises a plate that is constituted by a support made of inert material, a first composition, which is suitable to receive the image to be reproduced and is applied by means of conventional spreading systems to said support, and a second composition, which is sprayed onto the plate so as to generate the image to be reproduced. More particularly, it is important that the first composition comprises at least one anionic compound, while the second composition (hereinafter also termed “ink”) must comprise at least one cationic compound.

Without intending to be bound to specific operating mechanisms, it is believed that the present invention substantially uses the electrolytic interaction (anionic-cationic interaction) between the anionic compound contained in the first composition and the cationic compound comprised in the second composition.

Therefore, the described interaction produces a strong bonding of the second composition to the plate, at the same time preventing the occurrence of migration or surface spreading of said second composition, such phenomena being a dramatically important problem for the quality of the printing process.

In other words, an anionic mixture is applied to the entire surface of the hydrophilic support; said mixture comprises polymers which, if neutral, receive the addition of water-soluble salts, such as sulfurous salts (for example sulfonated salts) or carboxylate salts. In this manner, any droplet of a second cationic composition (ink) that arrives for example from the head of an inkjet system, by making contact with the anionic layer, instantaneously forms an insoluble macropolymer that precipitates within the fibers of the hydrophilic layer, accordingly preventing diffusion of said ink.

Therefore, differently from other known methods, in this case the instantaneous formation of a true chemical bond is used in order to ensure fixing of the second composition. This bond is not created after deposition of the ink (for example by using means such as laser diodes that modify the structure of the ink), but is generated simultaneously with the deposition of the second composition at the very instant in which said second composition makes contact with the first composition. Therefore, although a particularly preferred embodiment of the invention provides for further light- or heat-induced fixing of the second composition by suitable methods, the processes currently required before using the plate system are no longer a constraining aspect for the actual possibility to print.

Although only some preferred aspects of the method according to the invention are briefly described hereinafter, it should be understood that all the aspects presented in the description and the claims with reference to the individual elements, such as first composition, second composition, support etcetera, can also be applied to the method.

The inert support is made of a material such as for example electrograined-anodized aluminum, paper material or plastic material.

The support must ensure good resistance to the stresses that are typical of any printing process but at the same time must be flexible enough to be used in combination with the most disparate printing systems, such as for example preferably inkjet printing systems of the conventional type (for example ordinary inkjet printers).

The support can be made of a conventional material used for this purpose, such as electrograined-anodized aluminum, but also plastic material. Particularly, a plastic polymer (such as for example polyethylene terephthalate) is particularly preferred because of its qualities of flexibility, strength and low cost.

If a plastic material is used, it is necessary to pretreat the support with a high-temperature trifluoroacetic acid solution, so as to make the surface suitable to bind the polymers that will subsequently be applied to said support.

The first composition necessarily comprises at least one anionic compound and advantageously also at least one water-soluble polymer, at least one inorganic pigment and at least one initiator, wherein said initiator comprises at least one anionic compound.

In a first embodiment, the first composition applied to the support further comprises at least one of the following ingredients: at least one water-dispersible polymer, at least one crosslinking agent, at least one crosslinking process catalyst, at least one surfactant, and at least one product that improves the degree of reproduction of images and characters. Preferably, the first composition comprises all of the above ingredients.

Independently of the formulation of the first composition, the water-soluble polymer is used in a mixture with at least one water-dispersible polymer, which contributes for example to increasing the strength and lithographic performance of the water-soluble polymer.

Equally preferably, said water-soluble polymer comprises polyvinyl alcohol.

Initiators substantially are designed to facilitate and optimize the adhesion of a second composition used to reproduce the original image on said plate. Among the functions performed by the initiator, there are in fact two particularly important ones.

The first function consists in saturating the porosities that are present at the level of the basic hydrophilic layer where such porosity is not wanted. In this manner, any space in which the macropolymer generated as a consequence of the application of the second composition might migrate is closed. The consequence of this migration would in fact be an expansion of the lithographic dot, which would greatly reduce final printing quality.

A second advantage that is linked to the initiator is that since it contains at least one anionic compound, the charge density sufficient to firmly anchor the second composition is ensured.

The subsequent step of the method provides for spraying, by means of an inkjet printing system, a second composition that contains at least one cationic compound, which by fixing itself to definite regions of the plate differentiates so-called image areas from so-called non-image areas.

In the preferred case in which the cationic substance is also photosensitive, the second composition can be permanently fixed to the plate by means of a step of exposure to UVA-UVB light. In the case of heat-sensitive substances, it is sufficient to expose the plate system to a suitable heat source.

At this point, the plate system is ready to be used in a conventional lithographic printing process, in which however it is no longer necessary to modify the hydrophilicity of the surface that is not covered by the second composition by means of specific treatments, nor is it necessary to resort to processes for photographic developing of the plate system.

The method according to the invention does not require polluting chemicals for developing and preparation as provided in conventional lithographic printing procedures, developing machines, mountings of conventional films, or specialized operators.

A second aspect of the present invention relates to the individual components of a plate system as described above, and therefore to a support that receives the application of a first composition adapted to receive the image and a second composition used to reproduce the image.

The term “support” is used to designate a flexible lamina that is suitable to support the first composition that will receive the image.

As mentioned, said lamina is made for example of a flexible plastic polymer selected from the group that comprises cellulose triacetate, nitrocellulose, polystyrene, polyvinyl chloride, polyvinylidene chloride, polythene, high-density polyethylene, high-density polypropylene, polyarylsulfone, polyarylamide, polyarylimide, polyethylene terephthalate, polystyrene and mixtures thereof. High-density polypropylene, polyarylsulfone, polyarylamide and polyethylene terephthalate are particularly preferred because of their high dimensional and hygrometric stability.

However, a metallic support is also suitable to provide the present invention. In this case, preferred supports are made of electrograined-anodized aluminum.

If the support is made of plastics, (such as for example polyethylene terephthalate which is particularly preferred because of its mechanical, thermal and hygrometric properties), it is treated at 50 to 150° C., preferably between 80 and 120° C., even more preferably between 90 and 110° C., for a time comprised between 1 and 10 minutes, preferably between 2 and 4 minutes, with trichloroacetic acid at a concentration comprised between 10 and 20%, preferably 10%, where the percentages are expressed as by-weight ratios (like all the other percentages used here to define the present invention). Treatment advantageously but not necessarily occurs in the presence of variable quantities of silica, such as for example Aerosil or pyrogenic silica).

This treatment gives the support the ability to retain, by means of secondary chemical bonds known as Van der Waal bonds, a wide variety of resins and polymers that are soluble in water and in conventional solvents. For example, among the polymers that are bound, mention can be made of all the different kinds of polyvinyl alcohol with different degrees of hydrolysis, preferably fully hydrolyzed, hydrophilicity enhancing polymers such as alginic acids, carboxymethylcellulose, hydroxyethylcellulose, hydroxypropylcellulose, polyacrylic acids and all compounds that can be chemically likened to the ones described above.

Such polymers are also bonded effectively when they contain in suspension pigments of different kinds and having different functions, such as titanium dioxide, lead dioxide, selenium dioxide, zinc oxides, aluminum oxide, cadmium oxide and others.

The first composition applied to the support and suitable to receive the image substantially comprises an anionic compound. Advantageously, it comprises at least one water-soluble polymer, at least one inorganic pigment and at least one initiator. Preferably, the water-soluble polymer comprises polyvinyl alcohol and is used in a mixture with at least one water-dispersible polymer.

In particular, the combined use of polyvinyl alcohol and organic pigment allows to obtain a highly resistant layer that is accordingly suitable for the stresses involved in the printing process and also to obtain a highly porous structure. This facilitates the capacity of the hydrophilic layer to retain a good reserve of water during the printing process, this aspect being essential in order to maintain a balance between the water and the greasy ink and therefore an excellent end result.

The first composition preferably also comprises at least one crosslinking agent, at least one catalyst of the crosslinking process, and at least one surfactant, in addition to a product that improves the degree of reproduction of images and characters.

The expression “water-soluble polymers” is understood to designate all polymers that have chemical and physical characteristics (such as for example molecular weight and hydrophilicity) that are suitable to make them soluble in a highly polar medium such as water. These hydrophilicity characteristics can be determined for example by the presence of any polar chemical group, such as preferably hydroxyl and carboxyl groups.

Water-soluble polymers suitable to provide the present invention are selected from the group that comprises carboxymethylcellulose, hydroxymethylcellulose, hydroxyethylcellulose, hydroxypropylcellulose, alginates and alginic acids, polyvinylpyrrolidone, polyvinylpyrrolidone-vinyl acetate copolymers, polyvinyl alcohol-polyvinyl acetate copolymers, polyacrylic acids, polyacrylamides, polyacrylic and methacrylic acids, maleic-acrylic copolymers, ethylene-maleic anhydride copolymers, polyvinyl alcohols with a degree of hydrolysis comprised between 45 and 100%, preferably between 74 and 100%, even more preferably between 88 and 100%, and with a molecular weight comprised between 60,000 and 220,000 units, preferably between 90,000 and 220,000 units. All the polymers can in any case be used individually or mixed together. As mentioned more than once, particular preference is given to the use of polyvinyl alcohol or of mixtures between polyvinyl alcohol and hydrophilic polymers in which the polyvinyl alcohol is the main ingredient.

For 100 parts by weight of inorganic pigment, the presence of the hydrophilic polymers varies between 0.25 and 150 parts by weight, preferably between 0.5 and 15 parts by weight, even more preferably between 1 and 5 parts by weight. In the specific case of polyvinyl alcohol, it is present in 5 to 150 parts by weight, preferably 10 to 50 parts by weight, even more preferably 20 to 30 parts by weight.

A mixture of hydrophilic polymers according to the present invention can optionally contain also at least one product that improves the degree of reproduction of images and characters and for example facilitates the precipitation of cationic materials, especially photosensitive ones.

This ingredient is selected from the group that comprises anionic substances such as sulfur salts, such as sodium paratoluene sulfonate, sodium xylene sulfonate, sodium cumene sulfonate, sodium mesithylene sulfonate, sodium dihydroxynaphthalene disulfonate, sodium dihydroxynaphthalene sulfonate, sodium dihydroxybenzene sulfonate, sodium dihydroxybenzene disulfonate, sodium hydroxyquinone sulfonate, sodium 2,5-dihydroxybenzene sulfonate, sodium 4,5-dihydroxy-1,3-benzene disulfonate, sodium naphthalene sulfonate, sodium naphthalene disulfonate, sodium anthraquinone sulfonate, sodium anthraquinone-1,5-disulfonate, sodium 4-methylbenzene sulfonate, sodium 2-ethylbenzene sulfonate.

It is equally possible to use salts such as sodium salicylate, sodium phthalate, sodium terephthalate, sodium isophthalate, sodium 1,2,3- and 1,2,4-benzene tricarboxylate, sodium 1,2,4,5-benzene tetracarboxylate, sodium 3,3′,4,4′-benzophenone tetracarboxylate, sodium benzoate, sodium dihydroxybenzoate, sodium dimethoxybenzoate, sodium 4-hydroxybenzoate, sodium dimethylbenzoate, sodium trimethylbenzoate, sodium 1 and 2 naphthoate, sodium 1,4,5,8-naphthalene tetracarboxylate, sodium 1,8-naphthoate, sodium 4-hydroxy-3-methoxybenzoate, sodium sulfosalicylate and sodium sulfoisophthalate.

The expression “water-dispersible polymers” is used to designate all polymers having hydrophilicity characteristics suitable to make them dispersible in a polar medium such as water. Their presence in the first composition is not necessary; however, their use allows to optimize a number of parameters that are fundamentally important for the quality of the plate system and of the final prints.

Their physical and chemical characteristics in fact do not make them suitable to improve the binding of the polymer layer to the hydrophilic support, and therefore they are added substantially in order to increase the resistance of the soluble polymers to mechanical stresses during printing.

Water-dispersible polymers suitable to provide the present invention are preferably selected from the group that comprises styrene-butadiene polymers, styrene-acrylic copolymers, styrene-maleic anhydride copolymers, styrene-butadiene-acrylonitrile copolymers, copolymers of acrylic acid, methacrylic acid, methacrylate, ethyl acrylate, methyl methacrylate, ethyl methacrylate, and copolymers of polyvinyl acetate, polyvinyl propionate, polyvinyl butyrate. All the polymers can be used individually or mixed together.

The expression “crosslinking agent” is used to designate agents capable of leading to the formation of intermolecular and intramolecular chemical bonds in the water-soluble or water-dispersible polymers that have suitable chemical groups without however causing a significant decrease in the hydrophilicity of said polymers.

If one wishes to use them, for 100 parts by weight of inorganic pigment there are 0.4 to 80 parts by weight of crosslinking agents, preferably 2 to 30 parts by weight, even more preferably 4 to 20 parts by weight. In particular, for paraformaldehyde the most preferred interval is between 6 and 10 parts by weight, for glyoxylic acid it is between 10 and 18 parts by weight, and for glyoxal it is between 4 and 12 parts by weight.

The crosslinking agents are added substantially in order to obtain complex polymers and hydrophilic structures that withstand the various printing stresses.

The following can be mentioned among the different crosslinking agents that can be used in the present invention: formic aldehyde, formic acid, paraformaldehyde, acetic aldehyde, propionic aldehyde, butyric aldehyde, glutaric aldehyde, glyoxal, glyoxylic acid, vanillin, chlorobenzaldehyde, methoxybenzaldehyde, nitrobenzaldehyde, isophthalaldehyde, benzoic aldehyde, and substances that have affinity with them and mixtures thereof. All the crosslinking agents can be used individually or mixed together.

Among hydrophilic or water-dispersible polymers that can effectively crosslink under the action of the crosslinking agents according to the present invention, preference is given to those that have a large number of vicinal hydroxyls.

The expression “inorganic pigments” is used to designate inorganic compounds that are suitable to improve the printing process as a whole.

The pigments cited above react with the water-soluble or water-dispersible polymers cited above by way of secondary bonds and form, once applied in the treated plastic polymer support, porous hydrophilic structures that are highly resistant to surface abrasion.

In particular, although there is no intention to constrain the list of usable pigments to their function, it is believed that the advantage of adding said pigments resides substantially in their capacity to effectively structure the polymer layer by forming hydrogen bonds with the polar groups of said polymers.

In other words, the metals of said pigments, thanks to their basic properties (bases according to Lewis), act as structuring agents for the simple and crosslinked hydrophilic polymers, accordingly forming rigid and highly resistant skeletons.

The effectiveness of the pigments is immediate, but it can further increase as a consequence of particular treatments, such as thermal treatments that convert the hydrogen bonds into other types of chemically stronger bond. This transformation further contributes to further structuring of the hydrophilic layer, also increasing its porosity and therefore its water retention capacity. Such a thermal treatment provides for exposure of the plate to temperatures comprised between 100 and 150° C., preferably between 120 and 140° C., for a time comprised between 1 and 8 minutes, preferably between 2 and 4 minutes.

Among the pigments that are effectively used by the present invention, mention can be made of titanium dioxide, zinc oxides, aluminum oxides, alumina, lead dioxide, selenium dioxide, calcium carbonate, magnesium carbonate, kaolin, bentonite and chemically similar substances. Preference is given to pigments that have at least two oxygen atoms. All pigments can be used individually or mixed together.

The expression “accelerators and catalysts” is used to designate agents that accelerate and/or catalyze the formation of intermolecular or intramolecular bonds between the polymers in use.

Among the accelerators and/or catalysts used by the invention, mention can be made of oxalic acid, tartaric acid, itaconic acid, succinic acid, maleic acid, citric acid, formic acid and acetic acid. It is also possible to use sulfonic acids, such as paratoluene sulfonic acid, xylene sulfonic acid, cumene sulfonic acid, methylene sulfonic acid, mesithylene sulfonic acid, sulfosalicylic acid, sulfoisophthalic acid, methane sulfonic acid and sulfosuccinic acid. All the accelerators and catalysts can be used individually or mixed together. For 100 parts by weight of inorganic pigment, the presence of accelerators and catalysts varies between 0.5 and 5 parts by weight, preferably between 2 and 4 parts by weight.

The term “surfactant” is used to designate all anionic, cationic, amphoteric or non-ionic substances that are capable of modifying the surface tension of a liquid in liquid-liquid, liquid-gas pairs, or the wettability of a solid in contact with a liquid.

As regards their presence, the surfactants can be used in a concentration between 0.1 and 5% by weight, preferably between 0.5 and 3% by weight.

Such surfactants are added substantially in order to obtain a uniform, compact hydrophilic layer that is free from air bubbles. All known surfactants can be used; however, preference is given to those that have, at the percentages in which they are used, a surface tension comprised between 20 dynes/cm and 60 dynes/cm, and even greater preference is given to those having a surface tension comprised between 25 dynes/cm and 40 dynes/cm.

Among the surfactants that can be used according to the invention, mention can be made of inorganic salts of lauryl sarcosinate, lauryl sulfate, lauryl ethoxy sulfate, alkylbenzene sulfonate, sulfonated ethoxylated alkylphenols, sulfated ethoxylated alkylphenols, carboxylated ethoxylated alkylphenols, ethoxylated alcohols (such as for example ethoxylated glycerols and ethoxylated-propoxylated glycerols), ethylene oxide condensates of nonylphenol, ethoxysulfosuccinate, propoxylated and ethoxylated alkylphenols, dodecylbenzene sulfonate, isopropyl sulfosuccinate, sodium diisopropylnaphthalene sulfonate, sodium ethylhexanoate, isooctyl sulfosuccinate, dodecyl phenyl ether disulfonate, hexadecyl diphenyl oxide disulfonate, polyglycolethers of nonylphenol. The expression “inorganic salts” designates for example salts of alkaline metals, alkaline earth metals and ammonium.

The term “initiator” (or primer) is used to designate a substance that is capable of improving the application of the second composition and of achieving maximum fidelity in reproduction of images, drawings and characters.

Preferably, the primer is a water-soluble composition and necessarily comprises at least one anionic compound (such as compounds that comprise for example carboxyl groups or sulfur groups such as the sulfone group). The solution obtained starting from said water-soluble composition, independently of the nature of the anionic compounds that are present, has a concentration comprised between 5 and 150 g/l, preferably between 20 and 100 g/l, even more preferably between 45 and 65 g/l.

As noted more than once, therefore, the importance of the presence of the primer arises substantially from the fact that it saturates, where applied, the pores of the hydrophilic layer where said porosity would not be welcome. In other words, said porosity that is advantageous in the regions that must retain the water phase is instead harmful in regions onto which the second composition will be sprayed. Accordingly, the surprisingly effective solution of the present invention consists in applying a primer that blocks said pores in specific regions, avoiding the migration of the macropolymer that will be generated as a consequence of the application of the second composition.

Furthermore, the primer comprises an anionic compound, so that by increasing the negative charge density the effectiveness of the anchoring of the second cationic composition is consequently increased.

The advantageous presence of anionic charges in the primer can be obtained by selecting the anionic compound from the group that comprises at least one anionic polymer, carboxylated and/or sulfonated organic salts, and mixtures thereof. Said anionic polymer is optionally used in a mixture with neutral polymers, and said organic salts are preferably mixed with non-ionic polymers.

In the case of anionic polymers, the primer preferably comprises at least one anionic polymer selected from the group that comprises carboxymethylcellulose, polyacrylic acids, polyacrylic and methacrylic acids, maleic-acrylic copolymers, ethylene-maleic anhydride copolymers.

Examples of anionic salts are salts, preferably sodium salts, of salicylic acid, phthalic acid, terephtalic acid, isophthalic acid, trimellitic acid, pyromellitic acid, sulfosalicylic acid, sulfoisophthalic acid, 2-hydroxy-4-methoxybenzophenone-5-sulfonic acid, 2-hydroxy-3-methoxybenzoic acid, 2-hydroxy-5-methoxybenzoic acid, 4-hydroxy-3-methoxybenzoic acid (or vanillic acid).

Particular preference is given to primers that further comprise at least one ingredient selected from the group that consists of hydroxymethylcellulose, hydroxyethylcellulose, hydroxypropylcellulose, polyvinyl alcohols, with a degree of hydrolysis comprised between 45 and 100%, preferably between 74 and 100%, even more preferably between 88 and 100%, and with a molecular weight comprised between 60,000 and 220,000 units, preferably between 90,000 and 220,000 units and mixtures thereof. These optional ingredients in fact help to improve the physical properties of said primer.

Some preferred but non-limiting compositions of a primer according to the present invention will be described in greater detail in the experimental part.

A second composition according to the present invention substantially comprises a cationic compound.

In a preferred embodiment, said second composition comprises a mixture with a water or water-solvent base, which comprises at least one cationic substance (preferably usable as a salt), of the monomer or polymer type, preferably of the photosensitive or heat-sensitive type, which when sprayed onto the hydrophilic surface of a lithographic plate reacts locally with anionic substances provided in the first hydrophilic composition that is present on the surface of said plate. The concentration of cationic substances in the mixture is comprised between 20 and 400 g/l, preferably between 60 and 180 g/l, even more preferably between 90 and 120 g/l.

In this manner, a hydrophobic product is produced which precipitates into the residual porosities of the hydrophilic layer modified by superimposing the primer. After a subsequent and optional fixing (for example by exposure to UVA-UVB light in the case of photosensitive substances), permanent lithographic areas and dots are produced which have chemical affinity with the greasy inks used in conventional offset and webfed offset printing.

The step of spraying the second composition occurs by means of any inkjet system, such as preferably a plotter that is controlled by a computer in which the original image to be reproduced has been recorded.

A second photosensitive composition that is fully or partially water-based, like the one described above, is suitable to prepare printing plates that are capable of providing excellent performance, considerable image resolution, good reproduction fidelity, and a large print run.

As mentioned, the second water-based composition must contain at least one compound whose cationic portion, preferably if photosensitive, is capable of binding to the hydrophilic mixture that covers the support.

Among the cationic photosensitive compounds that can be used, particular preference is given to compounds that have at least one diazo group (—N₂+) in the polymer or monomer form. Among diazo derivatives, the preferred ones are selected from the group that comprises 4-diazodiphenylamine and its derivatives. In particular, preference is given to its derivatives that are substituted in position 3 with a radical selected from the group that consists of methoxy, ethoxy, propoxy, butoxy and to its derivatives that are bisubstituted in positions 3 and 6, where each substituent is selected independently from the group that consists of methoxy, ethoxy, propoxy and butoxy. Among bisubstituted derivatives, particular preference is given to dimethoxy, dipropoxy and dibutoxy derivatives.

Preferred examples of mono- or bisubstituted derivatives are 3-methoxydiazodiphenylamine, 3,6-dimethoxydiazodiphenylamine, and 3,6-dibutoxydiazodiphenylamine. These molecules are used equally as sulfate, chloride, bromide, iodide, nitrate, nitrite, chlorate, perchlorate, phosphate, hypophosphite, tetraborate, fluoborate and hexafluorophosphate salts. Moreover, as described in greater detail hereinafter, diazo derivatives substituted with methoxy, ethoxy, propoxy, butoxy groups also can be further modified at the level of the bridge between the two aromatic rings.

Another class of cationic substances that can be used but lacks the diazo group (and therefore is not photosensitive) comprises salts of para-aminodiphenylamine, para-aminobenzophenone and their optionally substituted derivatives. In the case of para-aminodiphenylamine sulfate and its substituted derivatives, since the amine group, preferably in para, is necessary for the formation of the diazo group, changes at the level of the bridge between the two aromatic rings are in any case possible. In particular, it is possible to modify the molecule by replacing the nitrogen atom with one or more atoms or chemical groups that are functionally equivalent, including for example methylene groups, carbonyl groups, oxygen atoms, sulfoxide groups, sulfone groups, sulfur atoms and an amide group. The anionic part of the molecules can be substituted with other common ions, such as for example chloride, bromide, iodide, nitrate, chlorate, perchlorate, iodate, periodate and bromate.

If one wishes to use the cationic substances as polymers, the basic structure of said polymers is substantially based on the pattern (-A-X-B-), in which A and B are two cationic or non-cationic monomers and X is a condensing agent used to polymerize the monomers.

Condensation can be performed either by using a single specific monomer (homopolymers, where A and B are identical) advantageously selected among the above cited photosensitive and non-photosensitive cationic compounds (preferably photosensitive ones, such as for example a diazo compound), or by involving also different cationic and non-cationic monomers (heterologous condensation or co-condensation). Since it is necessary to have at least one cationic compound, heteropolymers are thus generated in which A and B can be two different cationic compounds or a cationic compound and a neutral compound.

In the case of heteropolymers, the pattern (-A-X-B-) is meant to indicate that in the polymer skeleton it is possible to trace at least two different monomers. In other words, as a consequence of the polymerization mechanism itself, it is evident that the structure (-A-X-B-) may not correspond to the true minimum formula of the polymer and that a given pair of monomers A-B may not be repeated again in the rest of the polymer.

This detail becomes particularly important if one considers that mixing more than two different monomers or using even just two monomers but in different percentages are two of the possibilities that are perfectly compatible with the embodiment of the invention.

Therefore, part of the monomers involved in the condensation might not be cationic and therefore might not belong to the diazo compound class or to the class of cationic substances lacking the diazo group (such as salts of para-aminodiphenylamine, of para-aminobenzophenone, and of their derivatives).

Such non-cationic monomers that can be used in a co-condensation are selected from the group that comprises benzophenone, 2,4-dihydroxybenzophenone, 2,3,4-trihydroxybenzophenone, 2,3,4,4′-tetrahydroxybenzophenone, 2,2′,4,4′-tetrahydroxybenzophenone, phenylphenol, diphenyl ether, diphenyl methane, dicyclohexyl methane, diphenyl sulfone, diphenyl sulfoxide, diphenyl sulfide and their derivatives and mixtures.

The use of these non-cationic co-condensing agents in preparing the polymers arises from the wish to be able to increase the mass of the second composition (which, it is noted, is meant to act as an ink) without at the same time increasing the number of cationic groups that are present therein. An excessive increase in the cationic groups in fact entails, in addition to a number of difficulties in terms of easy handling of the composition, also a poor final print result and an extension of the times for depositing and fixing said second composition.

The adopted solution instead allows to increase at will the amount of ink available by using co-condensing agents, which can therefore constitute even most of the mass of the composition but the use of which in large amounts, thanks to their relative chemical inertia, does not have the drawbacks that can be associated with cationic derivatives.

In a fully general manner, condensations are preferably performed in an acid environment that provides for the presence of at least one acid selected from the group that comprises phosphoric acid, sulphuric acid, and methane sulfonic acid.

Independently of the type of condensation performed, the condensing agent is preferably selected from the group of compounds that comprises formic aldehyde, paraformaldehyde, acetic aldehyde, propionic aldehyde, butyric aldehyde, glyoxal, glyoxylic acid, glutaric aldehyde, glutaric dialdehyde, benzoic aldehyde, methoxy hydroxybenzaldehyde, chlorobenzaldehyde, nitrobenzaldehyde, isophthaldehyde and mixtures thereof. Preference is given to formic aldehyde, paraformaldehyde, acetic aldehyde, glyoxal, glyoxylic acid, glutaric aldehyde, glutaric dialdehyde, isophthaldehyde, and mixtures thereof.

If polymers (fully or partially photosensitive) are used, the composition of said inkjet solutions comprises 1 to 300 g/l of diazo condensate or diazo co-condensate. Preference is given to condensations comprised between 30 and 150 g/l; even more preference is given to concentrations between 50 and 150 g/l.

The second composition according to the invention can optionally contain also at least one of the substances selected from the group that consists of glycerol, ethylene glycol, propylene glycol, polyethylene glycol, fructose, saccharose, mannitol, xylitol, sorbitol, gluconic acid and their derivatives.

In order to facilitate inkjet application, the second composition according to the present invention can contain, in addition to water, also a percentage of at least one solvent selected from the group that comprises methyl alcohol, ethyl alcohol, propyl alcohol, isopropyl alcohol, butyl alcohol, dimethylacetamide, dimethylformamide and their derivatives.

Some preferred but non-limiting compositions of a second composition according to the present invention will become better apparent from the experimental part.

Further characteristics and advantages of the invention will become better apparent from the description of preferred but not exclusive embodiments of the method according to the invention, which are described hereinafter by way of non-limiting example.

### EXAMPLE 1

Examples of basic recipes for preparing solutions of a second photosensitive composition according to the invention are given hereafter:

| Ingredient | A | B | C | D | E |
|---|---|---|---|---|---|
| Dimethylacetamide | 25 ml | 25 ml | 35 ml | 35 ml | 35 ml |
| Dimethylformamide | 15 ml | 15 ml | — | — | — |
| Dowanol PM | 30 ml | 25 ml | 25 ml | 30 ml | 35 ml |
| Methyl alcohol | 20 ml | 20 ml | 20 ml | 20 ml | 20 ml |
| Isopropyl alcohol | 10 ml | 10 ml | 10 ml | 10 ml | 10 ml |
| Butyl alcohol | 2.5 ml | 2.5 ml | 2.5 ml | 2.5 ml | 2.5 ml |
| Demineralized water | 220 ml | 220 ml | 235 ml | 235 ml | 235 ml |
| Diazo FNO | 35 g | 30 g | 35 g | 30 g | 15 g |
| Diazo FSO | — | 10 g | 5 g | 5 g | 10 g |
| Diazo FSCO | 15 g | — | 5 g | 10 g | 30 g |
| Royal Blue FB | 1 g | — | 1 g | 1 g | — |
| Royal Blue FBO | — | 1 g | — | — | 1 g |

FNO is the trademark of the company “Materiali sensibili S.r.l.” for the polymer obtained starting from diazophenylamine sulfate, polymerized with paraformaldehyde in an environment that is acid by way of phosphoric acid;
FSO is the trademark of the company “Materiali sensibili S.r.l.” for the polymer obtained starting from diazophenylamine sulfate, polymerized with paraformaldehyde in an environment that is acid by way of sulfuric acid;
FSCO is the trademark of the company “Materiali sensibili S.r.l.” for the polymer obtained starting from diazophenylamine sulfate, polymerized with paraformaldehyde in an environment that is acid by way of sulfuric acid, and with the final addition of cobalt dichloride.

These three products have proved to be particularly advantageous because they lack inorganic reaction salts, since they are obtained by precipitation from alcohols.

### EXAMPLE 2

Examples of basic recipes for preparing solutions of initiators (primers) according to the invention are given hereinafter:

| Ingredient | A1 | B1 | C1 | D1 | E1 |
|---|---|---|---|---|---|
| Mowiol 18-88 | 20 g | 25 g | 20 g | — | — |
| Glascol E7 25% by | 15 ml | 10 ml | 15 ml | 15 ml | 20 ml |
| weight | | | | | |
| Sodium mesithylene | 8 g | — | — | 8 g | 10 g |
| sulfonate | | | | | |
| Sodium sulfosalicylate | — | 10 g | — | — | 15 g |
| Sodium sulfoisophthalate | — | — | 6 g | — | — |
| Sodium cumene | 2 g | — | — | — | — |
| sulfonate | | | | | |
| Sodium xylene sulfonate | — | 5 g | — | — | — |
| Sodium p-toluene | — | — | 2 g | — | — |
| sulfonate | | | | | |
| Sorbitol 70% by weight | 15 ml | — | 10 ml | — | 20 ml |
| Glycerol 28 Be 94% by | — | — | — | 15 ml | — |
| weight | | | | | |
| Dowfax 3B2 50% by | — | — | 25 ml | 30 ml | 25 ml |
| weight | | | | | |
| Demineralized water | 750 ml | 700 ml | 700 ml | 750 ml | 700 ml |
| Isopropyl alcohol | 200 ml | 200 ml | 200 ml | 200 ml | 200 ml |
| n-butyl alcohol | 50 ml | 50 ml | 50 ml | 50 ml | 50 ml |

### EXAMPLE 3

50 ml of a 10% solution of Airvol 350 are mixed together with 20 ml of a 6% solution of Ambergum 1221.

20 g of titanium dioxide rutile are separately dispersed in 50 ml of demineralized water and are then added to the solution of Airvol and Ambergum.

After approximately 30 minutes of vigorous agitation, 3.5 g of 37% formaldehyde, 1.2 g of citric acid, 5.5 g of 10% sodium dodecylbenzene sulfonate, 40 ml of isopropyl alcohol and 8 ml of n-butyl alcohol are added to the above solution. Mixing for another 15 minutes is then performed.

The mixture thus prepared is left to rest for 24 hours and then measured with a Ford no. 4 cup, providing a viscosity value comprised between 30″ and 40″.

The rested mixture is applied to a suitable 0.60 Majer bar so as to have 6-8 g/m² of dried substance on a polyester support treated beforehand with trichloroacetic acid at 10% for 4 minutes at 80° C. in the presence of 2% Aerosil 300 and Dowfax 3B2.

The lithographic plate thus prepared is then placed in a forced air circulation stove for 3 minutes at 120° C.

The plate is then immersed for 5 to 10 minutes in a tray that contains the primer A1 of example 2. Once extracted, it is left to percolate for a few minutes and is then dried, subjecting it to a moderate heat source comprised between 50 and 70° C.

At this point, the print support is introduced in an inkjet printing plotter controlled by a suitable program entered in an electronic computer; by using one of the second compositions of example 1 (second compositions A, B, C, D and E), drawings and images that conform with the original are generated.

The resulting lithographic plate system is exposed to an UVA-UVB light with a wavelength comprised between 340 and 480 nm, with λmax equal to 377 nm, a power of 2000 watts, for approximately 60 seconds until a constant shift of the color of the image areas is achieved (indicating that fixing of the second composition has occurred).

Finally, said plate system, introduced in an offset printing machine, proves to be capable of reproducing images conforming to the original of excellent quality with print runs on the order of 50,000-60,000 copies.

### EXAMPLE 4

50 ml of a 10% solution of Airvol 325 are mixed together with 30 ml of 5% Natrosol 250.

Separately, 18 g of zinc oxide and 6 g of aluminum oxide are first dispersed in 60 ml of demineralized water under intense agitation for 45 minutes and then added to the solution of Airvol and Natrosol.

Then, together with the previous solution, 3 g of 40% glyoxylic acid, 1.8 g of paratoluene sulfonic acid, 1.5 g of 30% lauryl ethoxy sulfate, 20 ml of ethyl alcohol, 25 ml of isopropyl alcohol, and 5 ml of n-butyl alcohol are added. Mixing is then performed for another 20 minutes.

The resulting mixture is left to rest for 18 hours. Then it is first measured in the Ford no. 4 cup, giving a viscosity value of 32″, and is then applied to a high-density polyethylene terephthalate support with an 0.50 Majer bar, so as to have a layer of dried substance comprised between 5 and 7 g/m². The support is treated beforehand with 12% trichloroacetic acid for 5 minutes at 90° C. in the presence of 4% Aerosil 400 and 0.9% Dowfax 3B2 and then placed in a forced air circulation stove for 2 minutes at 140° C.

The plate is then immersed for 5 to 10 minutes in a tray that contains the primer B1 of example 2. Once extracted, it is allowed to percolate for a few minutes and is then dried by subjecting it to a moderate heat source between 50 and 70° C.

Finally, the resulting lithographic plate system is exposed to a UVA-UVB light with a wavelength comprised between 340 and 480 nm, with λmax equal to 377 nm, a power of 2000 watts, for approximately 60 seconds, until a constant shift of the color of the image areas occurs (indicating that fixing of the second composition has occurred).

By subjecting the plate system to the same inkjet printing treatment described in the preceding example, images conforming to the original of excellent quality with print runs on the order of 40,000-50,000 copies have been obtained.

### EXAMPLE 5

60 ml of a 10% solution of Mowiol 56-98 are mixed together with 20 ml of a 10% solution of Glascol E9.

Separately, 14 g of zinc oxide and 12 g of titanium oxide are first dispersed in 75 ml of demineralized water and then added to the solution of Mowiol and Glascol.

After approximately 40 minutes of intense agitation, the preceding solution receives the addition of 2 g of 40% glyoxal, 1.5 g of sulfosalicylic acid, 0.8 g of 40% Surfynol 465, 25 ml of isopropyl alcohol, and 5 ml of n-butyl alcohol.

The resulting mixture is left under agitation for another 20 minutes and then made to rest for 24 hours, accordingly producing a No. 4 Ford cup viscosity value of 30″.

Then, by using an 0.50 Majer bar, the mixture is applied in a quantity equal to 6 g/m² of dried substance on a polyester support previously treated with 15% trichloroacetic acid for 3 minutes and at 70° C. in the presence of 5% Aerosil 600 and 1.2% sodium alkylbenzene sulfonate. Finally, the plate is placed in a forced air circulation stove for 4 minutes at 110° C.

The resulting lithographic plate is then subjected to a treatment with the primer C1 of example 2 and finally dried accurately.

Finally, the resulting lithographic plate system is exposed to a UVA-UVB light with a wavelength comprised between 340 and 480 nm, with λmax equal to 377 nm, a power of 2000 watts, for approximately 70 seconds until a constant shift of the color of the image areas is achieved (indicating that fixing of the second composition has occurred).

By subjecting the plate system to the same inkjet printing treatment described in example 3, images conforming to the original of excellent quality with print runs on the order of 50,000-60,000 have been obtained.

### EXAMPLE 6

40 ml of a 10% solution of Airvol 325 are mixed together with 30 ml of a 10% solution of fully hydrolyzed Gantrez AN 119.

Separately, 12 g of selenium dioxide, 14 g of zinc oxide and 3 g of aluminum oxide are first dispersed in 60 ml of demineralized water under intense agitation for 40 minutes and are then added to the solution of Airvol and Gantrez.

The above solution then receives the addition of 2 ml of a 70% solution of sulfosuccinic acid, 3 ml of 50% glutaric aldehyde, 1.2 g of 35% sodium diisooctyl sulfosuccinate, 20 ml of isopropyl alcohol, and 10 ml of n-butyl alcohol. The total mixture is then kept under agitation for 40 minutes and then left to rest for 24 hours. Viscosity measured by means of a Ford no. 4 cup yielded a value equal to 34″.

By means of a Majer bar, the mixture is then spread on a support so as to have a layer comprised between 8 and 9 g/m² of dried substance. The support is made of polyester and is pretreated as described in example 2.

The plate is then placed in a forced air circulation stove for 3 minutes at 120° C. and then immersed for 5 to 10 minutes in a tray that contains the primer D1 of example 2.

Finally, the resulting lithographic plate system is exposed to a UVA-UVB light with a wavelength comprised between 340 and 480 nm, with λmax equal to 377 nm, a power of 2000 watts, for approximately 70 seconds until a constant shift of the color of the image areas is achieved (indicating that fixing of the second composition has occurred).

By subjecting the plate system to the same inkjet printing treatment described in example 3, images conforming to the original of excellent quality with print runs on the order of 40,000 copies have been obtained.

### EXAMPLE 7

50 ml of a 10% solution of Mowiol 20-98 are mixed together with 25 ml of a 5% solution of Glascol E9.

Separately, 24 g of zinc oxide and 8 g of selenium dioxide are dispersed in 55 ml of demineralized water and are then added to the solution of Mowiol and Glascol.

After approximately 30 minutes of mixing, the preceding solution receives the addition of 2 g of 50% glyoxylic acid, 1 g of methanesulfonic acid, 0.8 g of 50% Surfynol 465, 25 ml of ethyl alcohol, 15 ml of isopropyl alcohol and 4 ml of n-butyl alcohol. The resulting disperse system is first left under agitation for 40 minutes and then allowed to rest for 18 hours. Evaluation of viscosity with a No. 4 Ford cup then yields a value equal to 36″.

By using a Majer bar, the mixture is then spread on a support so as to have a layer comprised between 8 and 10 g/m² of dried substance. The support is made of high-density polyethylene terephthalate and has been pretreated with 16% trichloroacetic acid at 100° C. in the presence of 2% Aerosil 400 and 0.8% Dowfax 3B2 for approximately 2 minutes. The plate is then placed in a forced air circulation stove for 6 minutes at 120° C.

The lithographic plate is then treated with the primer E1 of example 2 and accurately dried.

Finally, the resulting lithographic plate system is exposed to a UVA-UVB light with a wavelength comprised between 340 and 480 nm, with λmax equal to 377 nm, a power of 2000 watts, for approximately 80 seconds until a constant shift of the color of the image areas is achieved (indicating that fixing of the second composition has occurred).

By subjecting the plate system to the same inkjet printing treatment described in example 3, images conforming to the original of excellent quality with print runs on the order of 40,000-60,000 copies have been obtained.

The disclosures in Italian Patent Application No. M12003A001125 from which this application claims priority are incorporated herein by reference.

What is claimed is:

1. A method for producing a lithographic printing plate system, comprising the steps of:
a) providing a plate that is capable of receiving an image to be reproduced and comprises a first composition that comprises at least one anionic compound;
b) transferring an image to be reproduced onto said plate with the aid of a second composition and of an inkjet device, wherein said second composition comprises at least one cationic compound.

2. The method according to claim 1, wherein said plate comprises:
said first composition, which comprises:
at least one water-soluble polymer;
at least one inorganic pigment and at least one initiator, wherein said initiator comprises at least one anionic compound;
a support capable of binding said first composition.

3. The method according to claim 1, comprising after step b) an additional step of rendering said image recorded on the plate system permanent by way of a fixing treatment, said fixing depending on the type of said second composition that is used.

4. The method according to claim 3, wherein said fixing comprises a step of photofixing with UVA and/or UVB light.

5. A first composition for lithographic printing, comprising:
at least one water-soluble polymer;
at least one inorganic pigment and
at least one initiator, wherein said initiator comprises at least one anionic compound.

6. A plate for lithographic printing, comprising:
a first composition, which comprises:
at least one water-soluble polymer;
at least one inorganic pigment and
at least one initiator, wherein said initiator comprises at least one anionic compound;
a support capable of binding said first composition.

7. The plate according to claim 6, wherein said support is selected from the group consisting of electrograined-anodized aluminum, paper-like material and plastic material.

8. The plate according to claim 7, wherein said plastic material is selected from the group consisting of cellulose triacetate, nitrocellulose, polystyrene, polyvinyl chloride, polyvinylidene chloride, polythene, high-density polyethylene, high-density polypropylene, polyarylsulfone, polyarylamide, polyarylimide, polyethylene terephthalate, polystyrene and mixtures thereof.

9. The method according to claim 1, wherein said first composition further comprises at least one of the following ingredients:
i) at least one water-dispersible polymer,
ii) at least one crosslinking agent,
iii) at least one catalyst of the crosslinking process,
iv) at least one surfactant;
v) at least one product that improves the degree of reproduction of images and characters.

10. The first composition according to claim 5, further comprising at least one of the following ingredients:
i) at least one water-dispersible polymer,
ii) at least one crosslinking agent,
iii) at least one catalyst of the crosslinking process,
iv) at least one surfactant;
v) at least one product that improves the degree of reproduction of images and characters.

11. The plate according to claim 6, wherein said first composition further comprises at least one of the following ingredients:
i) at least one water-dispersible polymer,
ii) at least one crosslinking agent,
iii) at least one catalyst of the crosslinking process,
iv) at least one surfactant;
v) at least one product that improves the degree of reproduction of images and characters.

12. The method according to claim 1, wherein said water-soluble polymer is selected from the group consisting of carboxymethylcellulose, hydroxymethylcellulose, hydroxyethylcellulose, hydroxypropylcellulose, alginates and alginic acids, polyvinylpyrrolidone, polyvinylpyrrolidone-vinyl acetate copolymers, polyvinyl alcohol-polyvinyl acetate copolymers, polyacrylic acids, polyacrylamides, polyacrylic and methacrylic acids, maleic-acrylic copolymers, ethylene-maleic anhydride copolymers, at least one polyvinyl alcohol with a degree of hydrolysis comprised between 45 and 100% and with a molecular weight comprised between 60,000 and 220,000 units.

13. The first composition according to claim 5, wherein said water-soluble polymer is selected from the group consisting of carboxymethylcellulose, hydroxymethylcellulose, hydroxyethylcellulose, hydroxypropylcellulose, alginates and alginic acids, polyvinylpyrrolidone, polyvinylpyrrolidone-vinyl acetate copolymers, polyvinyl alcohol-polyvinyl acetate copolymers, polyacrylic acids, polyacrylamides, polyacrylic and methacrylic acids, maleic-acrylic copolymers, ethylene-maleic anhydride copolymers, at least one polyvinyl alcohol with a degree of hydrolysis comprised between 45 and 100% and with a molecular weight comprised between 60,000 and 220,000 units.

14. The plate according to claim 6, wherein said water-soluble polymer is selected from the group consisting of carboxymethylcellulose, hydroxymethylcellulose, hydroxyethylcellulose, hydroxypropylcellulose, alginates and alginic acids, polyvinylpyrrolidone, polyvinylpyrrolidone-vinyl acetate copolymers, polyvinyl alcohol-polyvinyl acetate copolymers, polyacrylic acids, polyacrylamides, polyacrylic and methacrylic acids, maleic-acrylic copolymers, ethylene-maleic anhydride copolymers, at least one polyvinyl alcohol with a degree of hydrolysis comprised between 45 and 100% and with a molecular weight comprised between 60,000 and 220,000 units.

15. The method according to claim 1, wherein said at least one water-soluble polymer is present in 0.25 to 150 parts by weight per 100 parts by weight of said inorganic pigment.

16. The first composition according to claim 5, wherein said at least one water-soluble polymer is present in 0.25 to 150 parts by weight per 100 parts by weight of said inorganic pigment.

17. The plate according to claim 6, wherein said at least one water-soluble polymer is present in 0.25 to 150 parts by weight per 100 parts by weight of said inorganic pigment.

18. The method according to claim 1, wherein said inorganic pigment is selected from the group consisting of titanium dioxide, zinc oxides, aluminum oxides, alumina, lead dioxide, selenium dioxide, calcium carbonate, magnesium carbonate, kaolin and bentonite.

19. The first composition according to claim 5, wherein said inorganic pigment is selected from the group consisting of titanium dioxide, zinc oxides, aluminum oxides, alumina, lead dioxide, selenium dioxide, calcium carbonate, magnesium carbonate, kaolin and bentonite.

20. The plate according to claim 6, wherein said inorganic pigment is selected from the group consisting of titanium dioxide, zinc oxides, aluminum oxides, alumina, lead dioxide, selenium dioxide, calcium carbonate, magnesium carbonate, kaolin and bentonite.

21. The method according to claim 1, wherein said anionic compound is selected independently from one of the following groups that consist of:
a) carboxymethylcellulose, polyacrylic acids, polyacrylic and methacrylic acids, maleic-acrylic copolymers, ethylene-maleic anhydride copolymers;
b) sodium salts of salicylic acid, phthalic acid, terephthalic acid, isophthalic acid, trimellitic acid, pyromellitic acid, sulfosalicylic acid, sulfoisophthalic acid, 2-hydroxy-4-methoxybenzophenone-5-sulfonic acid, 2-hydroxy-3-methoxybenzoic acid, 2-hydroxy-5-methoxybenzoic acid, and 4-hydroxy-3-methoxybenzoic acid.

22. The first composition according to claim 5, wherein said anionic compound is selected independently from one of the following groups that consist of:
a) carboxymethylcellulose, polyacrylic acids, polyacrylic and methacrylic acids, maleic-acrylic copolymers, ethylene-maleic anhydride copolymers;
b) sodium salts of salicylic acid, phthalic acid, terephthalic acid, isophthalic acid, trimellitic acid, pyromellitic acid, sulfosalicylic acid, sulfoisophthalic acid, 2-hydroxy-4-methoxybenzophenone-5-sulfonic acid, 2-hydroxy-3-methoxybenzoic acid, 2-hydroxy-5-methoxybenzoic acid, and 4-hydroxy-3-methoxybenzoic acid.

23. The plate according to claim 6, wherein said anionic compound is selected independently from one of the following groups that consist of:
a) carboxymethylcellulose, polyacrylic acids, polyacrylic and methacrylic acids, maleic-acrylic copolymers, ethylene-maleic anhydride copolymers;
b) sodium salts of salicylic acid, phthalic acid, terephthalic acid, isophthalic acid, trimellitic acid, pyromellitic acid, sulfosalicylic acid, sulfoisophthalic acid, 2-hydroxy-4-methoxybenzophenone-5-sulfonic acid, 2-hydroxy-3-methoxybenzoic acid, 2-hydroxy-5-methoxybenzoic acid, and 4-hydroxy-3-methoxybenzoic acid.

24. A second composition comprising at least one cationic substance.

25. The second composition according to claim 24, wherein said cationic compound is selected from the group consisting of diazo organic compounds, quaternary salts of para-aminodiphenylamine, quaternary salts of para-aminobenzophenone, and their derivatives and mixtures.

26. The second composition according to claim 25, wherein said diazo organic compounds are selected from the group consisting of 4-diazodiphenylamine and its derivatives and mixtures.

27. The second composition according to claim 26, wherein the 4-diazodiphenylamine derivatives are selected from the group consisting of:
derivatives that are monosubstituted in position 3 with a radical selected from the group that consists of methoxy, ethoxy, propoxy and butoxy; and
derivatives that are bisubstituted in positions 3 and 6, in which each substituent is independently selected from the group that consists of methoxy, ethoxy, propoxy and butoxy.

28. The second composition according to claim 27, wherein said diazo organic compound is selected from the group consisting of 3-methoxydiazodiphenylamine, 3,6-dimethoxydiazodiphenylamine, and 3,6-dibutoxydiazodiphenylamine.

29. The second composition according to claim 25, wherein said cationic compound is a monomer, a polymer or a mixture of monomers and polymers.

30. The second composition according to claim 29, wherein said polymer has a base structure defined as (-A-X-B-), where A and B are two monomers and X is a condensing agent.

31. The second composition according to claim 30, wherein
if A and B are identical, said polymer is a homopolymer,
if A and B are different, said polymer is a heteropolymer.

32. The second composition according to claim 31, wherein in said heteropolymers, the monomers A and B are independently selected from the following groups:
cationic compound according to claim 30,
compound, selected from the group consisting of benzophenone, 2,4-dihydroxybenzophenone, 2,3,4-trihydroxybenzophenone, 2,3,4,4′-tetrahydroxybenzophenone, 2,2′,4,4′-tetrahydroxybenzophenone, phenylphenol, diphenyl ether, diphenyl methane, dicyclohexyl methane, diphenyl sulfone, diphenyl sulfoxide, diphenyl sulfide and their derivatives and mixtures.

33. The second composition according to claim 30, wherein said condensing agent is selected from the group consisting of formic aldehyde, paraformaldehyde, acetic aldehyde, propionic aldehyde, butyric aldehyde, glyoxal, glyoxylic acid, glutaric aldehyde, glutaric dialdehyde, benzoic aldehyde, methoxy hydroxybenzaldehyde, chlorobenzaldehyde, nitrobenzaldehyde, isophthaldehyde, and mixtures thereof.

34. The second composition according to claim 24, further comprising at least one of the substances selected from the group that consists of glycerol, ethylene glycol, propylene glycol, polyethylene glycols, fructose, saccharose, mannitol, xylitol, sorbitol, gluconic acid and their derivatives.

35. The second composition according to claim 24, further comprising at least one solvent selected from the group consisting of methyl alcohol, ethyl alcohol, propyl alcohol, isopropyl alcohol, butyl alcohol, dimethylacetamide, dimethylformamide, and their derivatives.

36. A plate system for lithographic printing, comprising:
a) a plate according to claim 6, said plate being capable of receiving an image to be reproduced,
b) an image reproduced on said plate with the aid of a second composition according to claim 29 and of an inkjet printing device.
